(19) United States
(12) Patent Application Publication
(10) Pub. No.: US 2017/0169771 A1
(43) Pub. Date: Jun. 15, 2017

(54) Liquid Crystal Display And Control Method For The Same

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventor: Qingcheng ZUO, Shenzhen, Guangdong (CN)

(73) Assignees: Shenzhen China Star Optoelectronics Technology Co., Ltd., Shenzhen, Guangdong (CN); Wuhan China Star Optoelectronics Technology Co., Ltd., Wuhan, Hubei (CN)

(21) Appl. No.: 14/888,735

(22) PCT Filed: Aug. 25, 2015
(86) PCT No.: PCT/CN2015/088025

§ 371 Date: Nov. 3, 2015

(30) Foreign Application Priority Data
Aug. 7, 2015 (CN) 201510484335.X

(51) Int. Cl. G09G 3/36; G09G 3/20

(52) U.S. Cl. CPC G09G 3/3607; G09G 3/2003; G09G 3/3677; G09G 2320/0233; G09G 2300/0443; G09G 2300/0819; G09G 2310/0251

(57) ABSTRACT

A liquid crystal display and a control method are disclosed. The liquid crystal display includes: multiple data lines, multiple scanning lines and multiple pixel units, wherein, each pixel unit is connected with a corresponding data line and a corresponding scanning line, each pixel unit includes at least two sub-pixels arranged sequentially and having different colors, and the at least two sub-pixels having different colors in each pixel unit is charged by a same corresponding data line; and a control circuit for receiving multiple control signals and controlling the sub-pixels having different colors in the multiple pixel units to be charged simultaneously, wherein the multiple control signals are effective in a time-division manner in a scanning period of one scanning line. In the charging process, the sub-pixels which are charged simultaneously are not a single color so as to solve a brightness uneven problem in a charging switching period.

### BACKGROUND OF THE INVENTION

1. Field of the Invention

The present invention relates to a liquid crystal field, and more particularly to a liquid crystal display and a control method for the same.

2. Description of Related Art

Along with the development of the liquid crystal display (LCD), people demand a higher resolution for the LCD. Because the resolution is increased, the number of the data lines required for performing an output control is more and more. In order to reduce the number of the data lines of an LCD chip, a multiplexer (MUX) switching method is utilized to charge multiple sub-pixels having different colors using a same data line.

Wherein, in the charging process, the conventional art charges the sub-pixels having a same color at a same charging moment. In other words, when a liquid crystal display includes sub-pixels having three different colors, in the charging process, firstly, the sub-pixels having a first color are charged. Then, the sub-pixels having a second color are charged. Finally, the sub-pixels having a third color are charged. Because the sub-pixels having different colors have different light transmittances, that is, different brightnesses, in a charging switching period, the liquid crystal display will generate a brightness uneven problem.

### SUMMARY OF THE INVENTION

The main technology problem solved by the present invention is to provide a liquid crystal display and a control method in order to improve a brightness uneven problem generated in a charging switching period of the liquid crystal display.

In order to solve the above technology problem, a technology solution adopted by the present invention is: a liquid crystal display, comprising: multiple data lines, multiple scanning lines and multiple pixel units, wherein, each pixel unit is connected with a corresponding data line and a corresponding scanning line, each pixel unit includes at least two sub-pixels arranged sequentially and having different colors, and the at least two sub-pixels having different colors in each pixel unit is charged by a same corresponding data line; a control circuit for receiving multiple control signals and controlling the sub-pixels having different colors in the multiple pixel units to be charged simultaneously, wherein the multiple control signals are effective in a time-division manner in a scanning period of one scanning line in order to finish a charging of all sub-pixels corresponding to the one scanning line in the scanning period; wherein, the control circuit includes multiple control units corresponding to the multiple data lines one by one, each control unit includes a first switching element, a second switching element and a third switching element, each pixel unit includes a first sub-pixel, a second sub-pixel and a third sub-pixel having different colors, and the multiple control signals includes a first control signal, a second control signal and a third control signal; first terminals of the first switching element, the second switching element and the third switching element are respectively connected with the first sub-pixel, the second sub-pixel and the third sub-pixel; second terminals of the first switching element, the second switching element and the third switching element are connected with a same corresponding data line after being connected with each other; third terminals of the first switching element, the second switching element and the third switching element are respectively connected with the first control signal, the second control signal and the third control signal; each control unit has an arrangement manner for the control signals, and in three control units arranged sequentially, three arrangement manners of the control signals received at the third terminals of the first switching elements, the second switching elements and the third switching elements are different from each other or are the same partially such that the sub-pixels which are charged simultaneously are not a single color; wherein, the first sub-pixel, the second sub-pixel and the third sub-pixel are respectively a red sub-pixel, a green sub-pixel and a blue sub-pixel; and wherein, the first switching element, the second switching element and the third switching element are all NMOS transistors; the first terminals, the second terminals and the third terminals of the first switching element, the second switching element and the third switching element are respectively drain electrodes, source electrodes and gate electrodes of NMOS transistors.

Wherein, the three control units arranged sequentially are respectively denoted as a first control unit, a second control unit and a third control unit; three pixel units correspondingly connected with the first control unit, the second control unit and the third control unit arranged sequentially are respectively denoted as a first pixel unit, a second pixel unit and a third pixel unit; wherein, third terminals of the first switching element, the second switching element and the third switching element in the first control unit respectively receive the first control signal, the second control signal and the third control signal; third terminals of the first switching element, the second switching element and the third switching element in the second control unit respectively receive the third control signal, the first control signal and the second control signal; third terminals of the first switching element, the second switching element and the third switching element in the third control unit respectively receives the second control signal, the third control signal and the first control signal; wherein, when the first control signal is effective, the first sub-pixel in the first pixel unit, the second sub-pixel in the second pixel unit and the third sub-pixel in the third pixel unit are charged simultaneously; when the second control signal is effective, the second sub-pixel in the first pixel unit, the third sub-pixel in the second pixel unit and the first sub-pixel in the third pixel unit are charged simultaneously; and when the third control signal is effective, the third sub-pixel in the first pixel unit, the first sub-pixel in the second pixel unit and the second sub-pixel in the third pixel unit are charged simultaneously.

Wherein, the three control units arranged sequentially are respectively denoted as a first control unit, a second control unit and a third control unit; three pixel units correspondingly connected with the first control unit, the second control unit and the third control unit arranged sequentially are respectively denoted as a first pixel unit, a second pixel unit and a third pixel unit; wherein, third terminals of the first switching element, the second switching element and the third switching element in the first control unit respectively receive the first control signal, the second control signal and the third control signal; third terminals of the first switching element, the second switching element and the third switching element in the second control unit respectively receive the first control signal, the second control signal and the third control signal; third terminals of the first switching element, the second switching element and the third switching element in the third control unit respectively receives the third control signal, the first control signal and the second control signal; wherein, when the first control signal is effective, the first sub-pixel in the first pixel unit, the first sub-pixel in the second pixel unit and the second sub-pixel in the third pixel unit are charged simultaneously; when the second control signal is effective, the second sub-pixel in the first pixel unit, the second sub-pixel in the second pixel unit and the third sub-pixel in the third pixel unit are charged simultaneously; and when the third control signal is effective, the third sub-pixel in the first pixel unit, the third sub-pixel in the second pixel unit and the first sub-pixel in the third pixel unit are charged simultaneously.

Wherein, the first control signal, the second control signal and the third control signal are sequentially a high-level signal in the scanning period of one scanning line.

In order to solve the above technology problem, another technology solution adopted by the present invention is: multiple data lines, multiple scanning lines and multiple pixel units, wherein, each pixel unit is connected with a corresponding data line and a corresponding scanning line, each pixel unit includes at least two sub-pixels arranged sequentially and having different colors, and the at least two sub-pixels having different colors in each pixel unit is charged by a same corresponding data line; and a control circuit for receiving multiple control signals and controlling the sub-pixels having different colors in the multiple pixel units to be charged simultaneously, wherein the multiple control signals are effective in a time-division manner in a scanning period of one scanning line in order to finish a charging of all sub-pixels corresponding to the one scanning line in the scanning period.

Wherein, the control circuit includes multiple control units corresponding to the multiple data lines one by one, each control unit includes a first switching element, a second switching element and a third switching element, each pixel unit includes a first sub-pixel, a second sub-pixel and a third sub-pixel having different colors, and the multiple control signals includes a first control signal, a second control signal and a third control signal; first terminals of the first switching element, the second switching element and the third switching element are respectively connected with the first sub-pixel, the second sub-pixel and the third sub-pixel; second terminals of the first switching element, the second switching element and the third switching element are connected with a same corresponding data line after being connected with each other; third terminals of the first switching element, the second switching element and the third switching element are respectively connected with the first control signal, the second control signal and the third control signal; and each control unit has an arrangement manner for the control signals, and in three control units arranged sequentially, three arrangement manners of the control signals received at the third terminals of the first switching elements, the second switching elements and the third switching elements are different from each other or are the same partially such that the sub-pixels which are charged simultaneously are not a single color.

Wherein, the three control units arranged sequentially are respectively denoted as a first control unit, a second control unit and a third control unit; three pixel units correspondingly connected with the first control unit, the second control unit and the third control unit arranged sequentially are respectively denoted as a first pixel unit, a second pixel unit and a third pixel unit; wherein, third terminals of the first switching element, the second switching element and the third switching element in the first control unit respectively receive the first control signal, the second control signal and the third control signal; third terminals of the first switching element, the second switching element and the third switching element in the second control unit respectively receive the third control signal, the first control signal and the second control signal; third terminals of the first switching element, the second switching element and the third switching element in the third control unit respectively receives the second control signal, the third control signal and the first control signal; wherein, when the first control signal is effective, the first sub-pixel in the first pixel unit, the second sub-pixel in the second pixel unit and the third sub-pixel in the third pixel unit are charged simultaneously; when the second control signal is effective, the second sub-pixel in the first pixel unit, the third sub-pixel in the second pixel unit and the first sub-pixel in the third pixel unit are charged simultaneously; and when the third control signal is effective, the third sub-pixel in the first pixel unit, the first sub-pixel in the second pixel unit and the second sub-pixel in the third pixel unit are charged simultaneously.

Wherein, the three control units arranged sequentially are respectively denoted as a first control unit, a second control unit and a third control unit; three pixel units correspondingly connected with the first control unit, the second control unit and the third control unit arranged sequentially are respectively denoted as a first pixel unit, a second pixel unit and a third pixel unit; wherein, third terminals of the first switching element, the second switching element and the third switching element in the first control unit respectively receive the first control signal, the second control signal and the third control signal; third terminals of the first switching element, the second switching element and the third switching element in the second control unit respectively receive the first control signal, the second control signal and the third control signal; third terminals of the first switching element, the second switching element and the third switching element in the third control unit respectively receives the third control signal, the first control signal and the second control signal; wherein, when the first control signal is effective, the first sub-pixel in the first pixel unit, the first sub-pixel in the second pixel unit and the second sub-pixel in the third pixel unit are charged simultaneously; when the second control signal is effective, the second sub-pixel in the first pixel unit, the second sub-pixel in the second pixel unit and the third sub-pixel in the third pixel unit are charged simultaneously; and when the third control signal is effective, the third sub-pixel in the first pixel unit, the third sub-pixel in the second pixel unit and the first sub-pixel in the third pixel unit are charged simultaneously.

Wherein, the first sub-pixel, the second sub-pixel and the third sub-pixel are respectively a red sub-pixel, a green sub-pixel and a blue sub-pixel.

Wherein, the first switching element, the second switching element and the third switching element are all NMOS transistors; the first terminals, the second terminals and the third terminals of the first switching element, the second switching element and the third switching element are respectively drain electrodes, source electrodes and gate electrodes of NMOS transistors.

Wherein, the first control signal, the second control signal and the third control signal are sequentially a high-level signal in the scanning period of one scanning line.

In order to solve the above technology problems, another technology solution adopted by the present invention is: a control method for a liquid crystal display, comprising steps of: responding to multiple control signals to control sub-pixels having different colors in multiple pixel units to be charged simultaneously; wherein, the multiple control signals are effective in a time-division manner in a scanning period of one scanning line in order to finish a charging of all sub-pixels corresponding to the one scanning line in the scanning period.

Wherein, the multiple control signals includes a first control signal, a second control signal and a third control signal; each pixel unit includes a first sub-pixel, a second sub-pixel and a third sub-pixel having different colors; three of the pixel units arrange sequentially are respectively denoted as a first pixel unit, a second pixel unit and a third pixel unit; and in the step of responding to multiple control signals to control sub-pixels having different colors in multiple pixel units to be charged simultaneously includes: responding to the first control signal to control the first sub-pixel in the first pixel unit, the second sub-pixel in the second pixel unit and the third sub-pixel in the third pixel unit to be charged simultaneously; responding to the second control signal to control the second sub-pixel in the first pixel unit, the third sub-pixel in the second pixel unit and the first sub-pixel in the third pixel unit to be charged simultaneously; and responding to the third control signal to control the third sub-pixel in the first pixel unit, the first sub-pixel in the second pixel unit and the second sub-pixel in the third pixel unit to be charged simultaneously.

Wherein, the multiple control signals includes a first control signal, a second control signal and a third control signal; each pixel unit includes a first sub-pixel, a second sub-pixel and a third sub-pixel having different colors; three of the pixel units arrange sequentially are respectively denoted as a first pixel unit, a second pixel unit and a third pixel unit; and in the step of responding to multiple control signals to control sub-pixels having different colors in multiple pixel units to be charged simultaneously includes: responding to the first control signal to control the first sub-pixel in the first pixel unit, the first sub-pixel in the second pixel unit and the second sub-pixel in the third pixel unit to be charged simultaneously; responding to the second control signal to control the second sub-pixel in the first pixel unit, the second sub-pixel in the second pixel unit and the third sub-pixel in the third pixel unit to be charged simultaneously; and responding to the third control signal to control the third sub-pixel in the first pixel unit, the third sub-pixel in the second pixel unit and the first sub-pixel in the third pixel unit to be charged simultaneously.

The beneficial effect of the present invention is: in the present invention, the liquid crystal display and a control method for the same control the sub-pixels having different colors in the multiple pixel units to be charged simultaneously through multiple control signals. The multiple control signals are effective in a time-division manner in a scanning period of one scanning line in order to finish the charging of all sub-pixels corresponding to the scanning line in the scanning period. In the charging process, the sub-pixels which are charged simultaneously are not a single color so as to solve a brightness uneven problem in a charging switching period.

### BRIEF DESCRIPTION OF THE DRAWINGS

FIG. 1 is a schematic structure diagram of a liquid crystal display according to a first embodiment of the present invention;

FIG. 2 is a flowchart of a control method for the liquid crystal display shown in FIG. 1;

FIG. 3 is a schematic structure diagram of a liquid crystal display according to a second embodiment of the present invention;

FIG. 4 is a flowchart of a control method for the liquid crystal display shown in FIG. 3;

FIG. 5 is a schematic structure diagram of a liquid crystal display according to a third embodiment of the present invention; and

FIG. 6 is a flowchart of a control method for the liquid crystal display shown in FIG. 5.

### DETAILED DESCRIPTION OF THE PREFERRED EMBODIMENT

In the embodiment and claims of the present invention, some vocabularies are used to indicate some specific elements. A person skilled in the art can understand that manufacturers may use a different vocabulary to indicate a same element. The present embodiment and claims do not use the difference in the vocabularies to distinguish the elements. The present embodiment and claims utilize the difference in the functions of the elements to distinguish the elements. The following content combines with the drawings and the embodiment for describing the present invention in detail.

FIG. 1 is a schematic structure diagram of a liquid crystal display according to a first embodiment of the present invention. As shown in FIG. 1, the liquid crystal display includes: multiple data lines S(N) (N is a natural number), multiple scanning lines G(N) (N is a natural number), multiple pixel units 10 and a control circuit 20.

Each pixel unit 10 connects with a corresponding data line and a corresponding scanning line. Wherein, each pixel unit 10 includes at least two sub-pixels 101 arranged sequentially and having different colors. The at least two sub-pixels 101 having different colors in the pixel unit 10 are charged by a same corresponding data line S(N).

The control circuit 20 receives multiple control signals MUX, and controls the sub-pixels 101 having different colors in the multiple pixel units 10 to be charged simultaneously. Wherein, the multiple control signals MUX are effective in a time-division manner in a scanning period of one scanning line G(N) in order to finish the charging of all sub-pixels 101 corresponding to the scanning line G(N) in the scanning period.

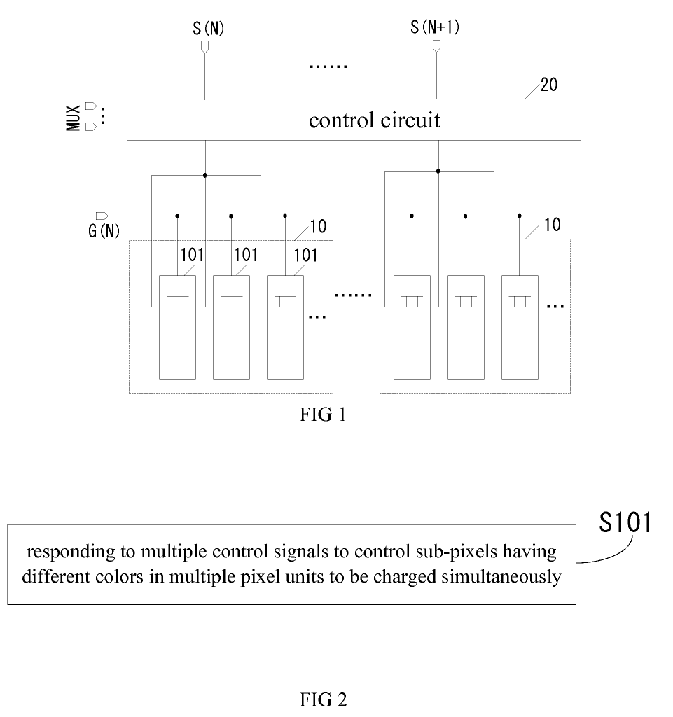

FIG. 2 is a flowchart of a control method for the liquid crystal display shown in FIG. 1. As shown in FIG. 2, the method includes following steps:

Step S101: responding to multiple control signals to control sub-pixels having different colors in multiple pixel units to be charged simultaneously.

In the step S101, the sub-pixels 101 having different colors in the same pixel units 10 are charged by a same corresponding data line S(N). The multiple control signals MUX are effective in a time-division manner in a scanning period of one scanning line G(N) in order to finish the charging of all sub-pixels 101 corresponding to the scanning line G(N) in the scanning period. Wherein, each control signal MUX controls the sub-pixels 101 having different colors in multiple pixel units 10 to be charged simultaneously.

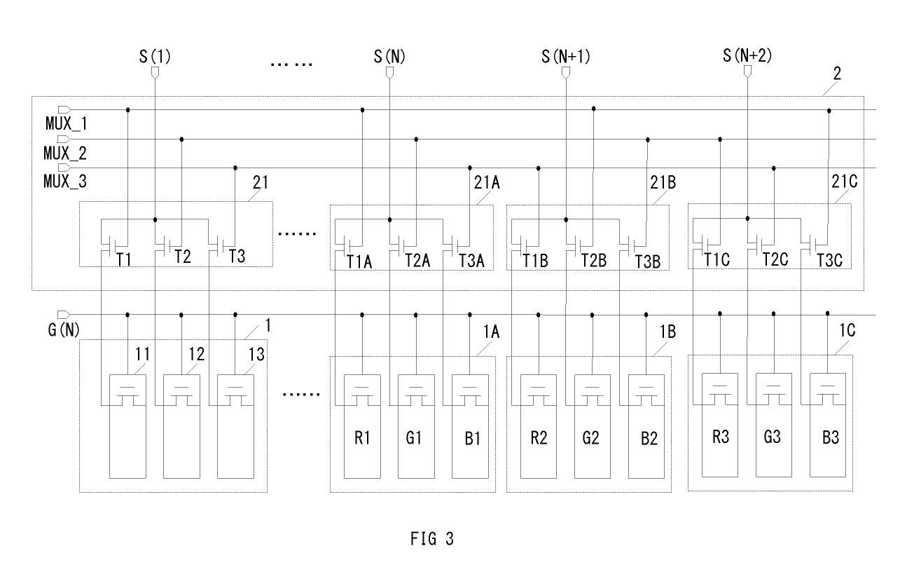

FIG. 3 is a schematic structure diagram of a liquid crystal display according to a second embodiment of the present invention. As shown in FIG. 3, the liquid crystal display includes: multiple data lines S(N) (N is a natural number), multiple scanning lines G(N) (N is a natural number), multiple pixel units 1 and a control circuit 2.

Each pixel unit 1 is connected with a corresponding data line and a corresponding scanning line. Each pixel unit 1 includes a first sub-pixel 11, a second sub-pixel 12 and a third sub-pixel 13 having different colors. The first sub-pixel 11, the second sub-pixel 12 and the third sub-pixel 13 are respectively corresponding to a red sub-pixel, a green sub-pixel and a blue sub-pixel. Wherein, the first sub-pixel 11, the second sub-pixel 12 and the third sub-pixel 13 in each pixel unit 1 are charged by a same corresponding data line.

The control circuit 2 receives the multiple control signals, and controls the first sub-pixels 11, the second sub-pixels 12 and the third sub-pixels 13 having different colors in the multiple pixel units 1 to be charged simultaneously. Wherein, the multiple control signals include a first control signal MUX_1, a second control signal MUX_2 and a third control signal MUX_3.

The control circuit 2 includes multiple control units 21 corresponding to the multiple data lines one by one. Each control unit 21 includes a first switching element T1, a second switching element T2 and a third switching element T3.

Wherein, the first switching element T1, the second switching element T2 and the third switching element T3 are NMOS transistors. A first terminal, a second terminal and a third terminal of each of the first switching element T1, the second switching element T2 and the third switching element T3 are respectively corresponding to a drain electrode, a source electrode and a gate electrode of a NMOS transistor.

The first terminals of the first switching element T1, the second switching element T2 and the third switching element T3 are respectively connected with the first sub-pixel 11, the second sub-pixel 12 and the third sub-pixel 13. The second terminals of the first switching element T1, the second switching element T2 and the third switching element T3 are connected with a same corresponding data line after being connected with each other. The third terminals of the first switching element T1, the second switching element T2 and the third switching element T3 are respectively connected with the first control signal MUX_1, the second control signal MUX_2 and the third control signal MUX_3. Each control unit has an arrangement manner of the control signals (MUX_1, MUX_2 and MUX_3). In three control units 21 arranged sequentially, three arrangement manners of the control signals received at the third terminals of the first switching elements T1, the second switching elements T2 and the third switching elements T3 are different from each other.

Specifically, in order to conveniently describe the present invention, the three control units 21 arranged sequentially are respectively denoted as a first control unit 21A, a second control unit 21B and a third control unit 21C. Three pixel units 1 correspondingly connected with the first control unit 21A, the second control unit 21B and the third control unit 21C arranged sequentially are respectively denoted as a first pixel unit 1A, a second pixel unit 1B and a third pixel unit 1C. The first control unit 21A includes a first switching element T1A, a second switching element T2A, a third switching element T3A. The second control unit 21B includes a first switching element T1B, a second switching element T2B and a third switching element T3B. The third control unit 21C includes a first switching element T1C, a second switching element T2C and a third switching element T3C. The first pixel unit 1A includes a first sub-pixel R1, a second sub-pixel G1 and a third sub-pixel B1. The second pixel unit 1B includes a first sub-pixel R2, a second sub-pixel G2 and a third sub-pixel B2. The third pixel unit 1C includes a first sub-pixel R3, a second sub-pixel G3 and a third sub-pixel B3.

In the first control unit 21A, first terminals of the first switching element T1A, the second switching element T2A and the third switching element T3A are respectively connected with the first sub-pixel R1, the second sub-pixel G1 and the third sub-pixel B1 in the first pixel unit 1A. Second terminals of the first switching element T1A, the second switching element T2A and the third switching element T3A are connected with the data line S(N) after the second terminals of the first switching element T1A, the second switching element T2A and the third switching element T3A are connected with each other. Third terminals of the first switching element T1A, the second switching element T2A and the third switching element T3A respectively receive the first control signal MUX_1, the second control signal MUX_2 and the third control signal MUX_3.

In the second control unit 21B, first terminals of the first switching element T1B, the second switching element T2B and the third switching element T3B are respectively connected with the first sub-pixel R2, the second sub-pixel G2 and the third sub-pixel B2 in the second pixel unit 1B. Second terminals of the first switching element T1B, the second switching element T2B and the third switching element T3B are connected with the data line S(N+1) after the second terminals of the first switching element T1B, the second switching element T2B and the third switching element T3B are connected with each other. Third terminals of the first switching element T1B, the second switching element T2B and the third switching element T3B respectively receive the third control signal MUX_3, the first control signal MUX_1 and the second control signal MUX_2.

In the third control unit 21C, first terminals of the first switching element T1C, the second switching element T2C and the third switching element T3C are respectively connected with the first sub-pixel R3, the second sub-pixel G3 and the third sub-pixel B3 in the third pixel unit 1C. Second terminals of the first switching element T1C, the second switching element T2C and the third switching element T3C are connected with the data line S(N+2) after the second terminals of the first switching element T1C, the second switching element T2C and the third switching element T3C are connected with each other. Third terminals of the first switching element T1C, the second switching element T2C and the third switching element T3C respectively receives the second control signal MUX_2, the third control signal MUX_3 and the first control signal MUX_1.

When the scanning line G (N) is turned on, that is, under a scanning period, and when the first control signal MUX_1 is effective, that is, the first control signal MUX_1 is a high-level signal, the first switching element T1A in the first control unit 21A, the second switching element T2B in the second control unit 21B and the third switching element T3C in the third control unit 21C are turned on (conductive) simultaneously such that simultaneously, the data line S(N) charges the first sub-pixel R1 in the first pixel unit 1A, the data line S(N+1) charges the second sub-pixel G2 in the second pixel unit 1B and the data line S(N+2) charges the third sub-pixel B3 in the third pixel unit 1C. In other words, when the first control signal MUX_1 is effective, the sub-pixels which are charged simultaneously on the liquid crystal display device includes the first sub-pixel R1, the second sub-pixel G2 and the third sub-pixel B3, which are sub-pixels having three different colors.

When the scanning line G (N) is turned on, that is, under a scanning period, and when the second control signal MUX_2 is effective, that is, the second control signal MUX_2 is a high-level signal, the second switching element T2A in the first control unit 21A, the third switching element T3B in the second control unit 21B and the first switching element T1C in the third control unit 21C are turned on (conductive) simultaneously such that simultaneously, the data line S(N) charges the second sub-pixel G1 in the first pixel unit 1A, the data line S(N+1) charges the third sub-pixel B2 in the second pixel unit 1B and the data line S(N+2) charges the first sub-pixel R3 in the third pixel unit 1C. In other words, when the second control signal MUX_2 is effective, sub-pixels which are charged simultaneously on the liquid crystal display device includes the second sub-pixel G1, the third sub-pixel B2 and the first sub-pixel R1, which are sub-pixels having three different colors.

When the scanning line G (N) is turned on, that is, under a scanning period, and when the third control signal MUX_3 is effective, that is, the third control signal MUX_3 is a high-level signal, the third switching element T3A in the first control unit 21A, the first switching element T1B in the second control unit 21B and the second switching element T2C in the third control unit 21C are turned on (conductive) simultaneously such that simultaneously, the data line S(N) charges the third sub-pixel B1 in the first pixel unit 1A, the data line S(N+1) charges the first sub-pixel R2 in the second pixel unit 1B and the data line S(N+2) charges the second sub-pixel G3 in the third pixel unit 1C. In other words, when the third control signal MUX_3 is effective, sub-pixels which are charged simultaneously on the liquid crystal display device includes the third sub-pixel B1, the first sub-pixel R2 and the second sub-pixel G3, which are sub-pixels having three different colors.

In the scanning period of one scanning line G(N), when the first control signal MUX_1, the second control signal MUX_2 and the third control signal MUX_3 are sequentially a high-level signal in a time-division manner, the data line S(N), S(N+1) and S(N+2) charge the first sub-pixel R1, the second sub-pixel G2 and the third sub-pixel B3 firstly; then, charge the second sub-pixel G1, the third sub-pixel B2 and the first sub-pixel R3; finally charge the third sub-pixel B1, the first sub-pixel R2 and the second sub-pixel G3. Accordingly, charging all of the sub-pixels corresponding to the one scanning line G(N) is finished in the scanning period of the scanning line G(N). Wherein, in the process that the scanning lines G(N) are effective one row by one row, repeating the above operations can finish the charging for the entire liquid crystal display.

In the present embodiment, in the charging process, for anytime in charging, because the sub-pixels which are charged at the same time include R, G and B sub-pixels having three different colors so that in a charging switching period, the brightness of the liquid crystal display can be maintained evenly.

One person skilled in the art can understand that the present invention is not limited to the arrangement manners of the control signals received at the third terminals of the first switching elements, the second switching elements and the third switching elements described at the above embodiments. The requirement is that in three control units arranged sequentially, three arrangement manners of the control signals received at the third terminals of the first switching elements, the second switching elements and the third switching elements are different from each other such that the sub-pixels which are charged at the same time including R, G and B sub-pixels having three different colors is covered by the claims of the present invention.

For example, the third terminals of the first switching element T1A, the second switching element T2A and the third switching element T3A correspondingly receives the second control signal MUX_2, the first control signal MUX_1 and the third control signal MUX_3. The third terminals of the first switching element T1B, the second switching element T2B and the third switching element T3B correspondingly receives the first control signal MUX_1, the third control signal MUX_3 and the second control signal MUX_2. The third terminals of the first switching element T1C, the second switching element T2C and the third switching element T3C correspondingly receives the third control signal MUX_3, the second control signal MUX_2 and the first control signal MUX_1. Accordingly, in the scanning period of the scanning line G(N), when the first control signal MUX_1, the second control signal MUX_2 and the third control signal MUX_3 are sequentially a high-level signal in a time-division manner, the data lines S(N), S(N+1) and S(N+2) charge the second sub-pixel G1, the first sub-pixel R2 and the third sub-pixel B3 firstly, then, charge the first sub-pixel R1, the third sub-pixel B2 and the second sub-pixel G3, and finally, charge the third sub-pixel B1, the second sub-pixel G2 and the first sub-pixel R3. The other arrangement manners are shown one by one.

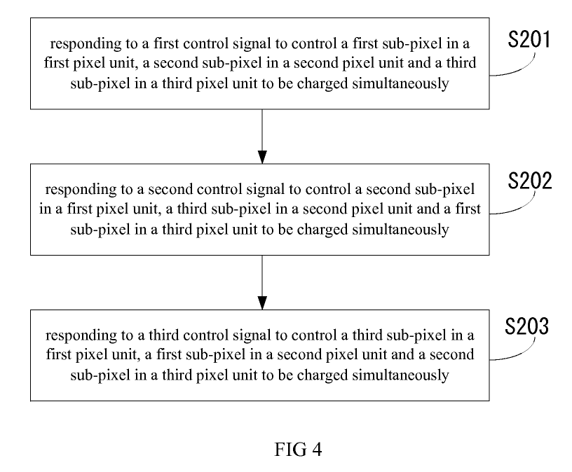

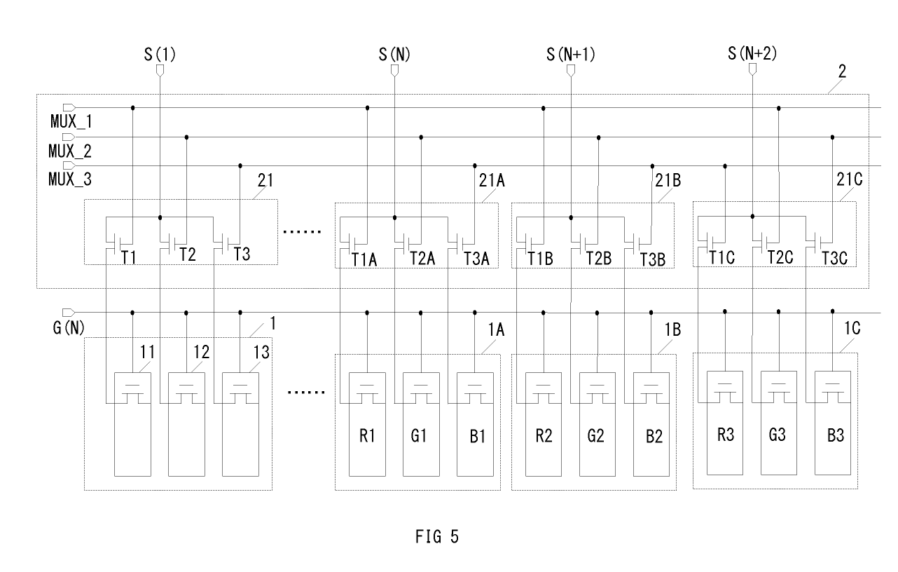

FIG. 4 is a flowchart of a control method for the liquid crystal display shown in FIG. 3. It should be noted that if there exists an actual same result, the method of the present invention is not limited to the sequence of the flow chart shown in FIG. 4. As shown in FIG. 4, the method comprises following steps:

Step S201: responding to a first control signal to control a first sub-pixel in a first pixel unit, a second sub-pixel in a second pixel unit and a third sub-pixel in a third pixel unit to be charged simultaneously.

In the step S201, when the first control signal MUX_1 is effective, the first switching element T1A in the first control unit 21A, the second switching element T2B in the second control unit 21B and the third switching element T3C in the third control unit 21C are turned on (conductive) simultaneously such that simultaneously, the data line S(N) charges the first sub-pixel R1 in the first pixel unit 1A, the data line S(N+1) charges the second sub-pixel G2 in the second pixel unit 1B and the data line S(N+2) charges the third sub-pixel B3 in the third pixel unit 1C.

Step S202: responding to a second control signal to control a second sub-pixel in a first pixel unit, a third sub-pixel in a second pixel unit and a first sub-pixel in a third pixel unit to be charged simultaneously.

In the step S202, when the second control signal MUX_2 is effective, the second switching element T2A in the first control unit 21A, the third switching element T3B in the second control unit 21B and the first switching element T1C in the third control unit 21C are turned on (conductive) simultaneously such that simultaneously, the data line S(N) charges the second sub-pixel G1 in the first pixel unit 1A, the data line S(N+1) charges the third sub-pixel B2 in the second pixel unit 1B and the data line S(N+2) charges the first sub-pixel R3 in the third pixel unit 1C.

Step S203: responding to a third control signal to control a third sub-pixel in a first pixel unit, a first sub-pixel in a second pixel unit and a second sub-pixel in a third pixel unit to be charged simultaneously.

In the step S203, when the third control signal MUX_3 is effective, the third switching element T3A in the first control unit 21A, the first switching element T1B in the second control unit 21B and the second switching element T2C in the third control unit 21C are turned on (conductive) simultaneously such that simultaneously, the data line S(N) charges the third sub-pixel B1 in the first pixel unit 1A, the data line S(N+1) charges the first sub-pixel R2 in the second pixel unit 1B and the data line S(N+2) charges the second sub-pixel G3 in the third pixel unit 1C.

Wherein, the first control signal MUX_1, the second control signal MUX_2 and the third control signal MUX_3 are effective in a time-division manner in a scanning period of one scanning line G(N) so that after finishing the step S201 to step S203, the charging of all sub-pixels corresponding to the scanning line G(N) is finished. In the process of sequentially scanning of multiple scanning lines G(N), repeating the step S201 to the step S203 can finish the charging for the entire liquid crystal display.

FIG. 5 is a schematic structure diagram of a liquid crystal display according to a third embodiment of the present invention. The difference between the liquid crystal display shown in FIG. 5 and the liquid crystal display shown in FIG. 3 is: in three control units arranged sequentially, three arrangement manners of the control signals received at the third terminals of the first switching elements, the second switching elements and the third switching elements are different from each other such that sub-pixels which are charged simultaneously includes two types of sub-pixels having different colors.

Specifically, the third terminals of the first switching element T1A, the second switching element T2A and the third switching element T3A in the first control unit 21A respectively receives the first control signal MUX_1, the second control signal MUX_2 and the third control signal MUX_3. Third terminals of the first switching element T1B, the second switching element T2B and the third switching element T3B in the second control unit 21B respectively receives the first control signal MUX_1, the second control signal MUX_2 and the third control signal MUX_3. Third terminals of the first switching element TIC, the second switching element T2C and the third switching element T3C in the third control unit 21C respectively receives the third control signal MUX_3, the first control signal MUX_1 and the second control signal MUX_2.

Wherein, when the first control signal MUX_1 is effective, the first sub-pixel R1 in the first pixel unit 1A, the first sub-pixel R2 in the second pixel unit 1B and the second sub-pixel G3 in the third pixel unit 1C are charged simultaneously.

Wherein, when the second control signal MUX_2 is effective, the second sub-pixel G1 in the first pixel unit 1A, the second sub-pixel G2 in the second pixel unit 1B and the third sub-pixel B3 in the third pixel unit 1C are charged simultaneously.

Wherein, when the third control signal MUX_3 is effective, the third sub-pixel B1 in the first pixel unit 1A, the third sub-pixel B2 in the second pixel unit 1B and the first sub-pixel R3 in the third pixel unit 1C are charged simultaneously.

One person skilled in the art can understand that the present invention is not limited to the arrangement manners of the control signals received at the third terminals of the first switching elements, the second switching elements and the third switching elements described at the above embodiments. The requirement is that in three control units arranged sequentially, three arrangement manners of the control signals received at the third terminals of the first switching elements, the second switching elements and the third switching elements are different from each other such that the sub-pixels which are charged at the same time including R, G and B sub-pixels having three different colors is covered by the claims of the present invention.

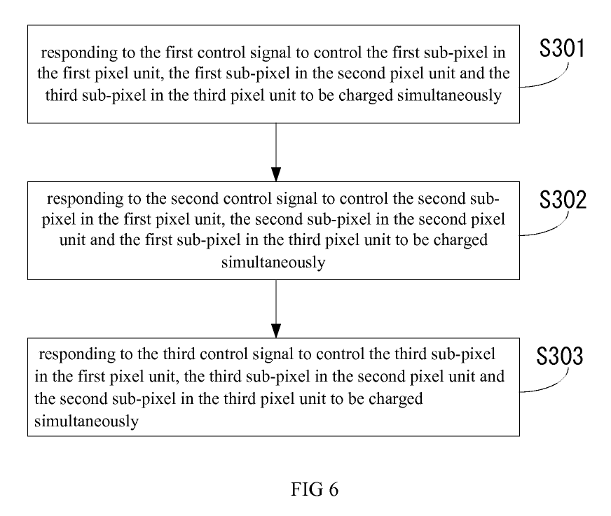

FIG. 6 is a flowchart of a control method for the liquid crystal display shown in FIG. 5. It should be noted that if there exists an actual same result, the method of the present invention is not limited to the sequence of the flow chart shown in FIG. 6. As shown in FIG. 6, the method comprises following steps:

Step S301: responding to the first control signal to control the first sub-pixel in the first pixel unit, the first sub-pixel in the second pixel unit and the second sub-pixel in the third pixel unit to be charged simultaneously.

Step S302: responding to the second control signal to control the second sub-pixel in the first pixel unit, the second sub-pixel in the second pixel unit and the third sub-pixel in the third pixel unit to be charged simultaneously.

Step S303: responding to the third control signal to control the third sub-pixel in the first pixel unit, the third sub-pixel in the second pixel unit and the first sub-pixel in the third pixel unit to be charged simultaneously.

Wherein, the first control signal MUX_1, the second control signal MUX_2 and the third control signal MUX_3 are effective in a time-division manner in a scanning period of one scanning line G(N) so that after finishing the step S301 to step S303, the charging of all sub-pixels corresponding to the scanning line G(N) is finished. In the process of sequentially scanning of multiple scanning lines G(N), repeating the step S301 to the step S303 can finish the charging for the entire liquid crystal display.

In the present embodiment, in the charging process, for anytime in charging, because the sub-pixels which are charged at the same time include two types of the sub-pixels having different colors so that in a charging switching period, the brightness of the liquid crystal display can be maintained evenly.

The beneficial effect of the present invention is: in the present invention, the liquid crystal display and a control method for the same control the sub-pixels having different colors in the multiple pixel units to be charged simultaneously through multiple control signals. The multiple control signals are effective in a time-division manner in a scanning period of one scanning line in order to finish the charging of all sub-pixels corresponding to the scanning line in the scanning period. In the charging process, the sub-pixels which are charged simultaneously are not a single color so as to solve a brightness uneven problem in a charging switching period.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A liquid crystal display, comprising:
multiple data lines, multiple scanning lines and multiple pixel units, wherein, each pixel unit is connected with a corresponding data line and a corresponding scanning line, each pixel unit includes at least two sub-pixels arranged sequentially and having different colors, and the at least two sub-pixels having different colors in each pixel unit is charged by a same corresponding data line;
a control circuit for receiving multiple control signals and controlling the sub-pixels having different colors in the multiple pixel units to be charged simultaneously, wherein the multiple control signals are effective in a time-division manner in a scanning period of one scanning line in order to finish a charging of all sub-pixels corresponding to the one scanning line in the scanning period;
wherein, the control circuit includes multiple control units corresponding to the multiple data lines one by one, each control unit includes a first switching element, a second switching element and a third switching element, each pixel unit includes a first sub-pixel, a second sub-pixel and a third sub-pixel having different colors, and the multiple control signals includes a first control signal, a second control signal and a third control signal;
first terminals of the first switching element, the second switching element and the third switching element are respectively connected with the first sub-pixel, the second sub-pixel and the third sub-pixel; second terminals of the first switching element, the second switching element and the third switching element are connected with a same corresponding data line after being connected with each other; third terminals of the first switching element, the second switching element and the third switching element are respectively connected with the first control signal, the second control signal and the third control signal;
each control unit has an arrangement manner for the control signals, and in three control units arranged sequentially, three arrangement manners of the control signals received at the third terminals of the first switching elements, the second switching elements and the third switching elements are different from each other or are the same partially such that the sub-pixels which are charged simultaneously are not a single color;
wherein, the first sub-pixel, the second sub-pixel and the third sub-pixel are respectively a red sub-pixel, a green sub-pixel and a blue sub-pixel; and
wherein, the first switching element, the second switching element and the third switching element are all NMOS transistors; the first terminals, the second terminals and the third terminals of the first switching element, the second switching element and the third switching element are respectively drain electrodes, source electrodes and gate electrodes of NMOS transistors.

2. The liquid crystal display according to claim 1, wherein, the three control units arranged sequentially are respectively denoted as a first control unit, a second control unit and a third control unit; three pixel units correspondingly connected with the first control unit, the second control unit and the third control unit arranged sequentially are respectively denoted as a first pixel unit, a second pixel unit and a third pixel unit;
wherein, third terminals of the first switching element, the second switching element and the third switching element in the first control unit respectively receive the first control signal, the second control signal and the third control signal; third terminals of the first switching element, the second switching element and the third switching element in the second control unit respectively receive the third control signal, the first control signal and the second control signal; third terminals of the first switching element, the second switching element and the third switching element in the third control unit respectively receives the second control signal, the third control signal and the first control signal;
wherein, when the first control signal is effective, the first sub-pixel in the first pixel unit, the second sub-pixel in the second pixel unit and the third sub-pixel in the third pixel unit are charged simultaneously;
when the second control signal is effective, the second sub-pixel in the first pixel unit, the third sub-pixel in the second pixel unit and the first sub-pixel in the third pixel unit are charged simultaneously; and
when the third control signal is effective, the third sub-pixel in the first pixel unit, the first sub-pixel in the second pixel unit and the second sub-pixel in the third pixel unit are charged simultaneously.

3. The liquid crystal display according to claim 1, wherein, the three control units arranged sequentially are respectively denoted as a first control unit, a second control unit and a third control unit; three pixel units correspondingly connected with the first control unit, the second control unit and the third control unit arranged sequentially are respectively denoted as a first pixel unit, a second pixel unit and a third pixel unit;
wherein, third terminals of the first switching element, the second switching element and the third switching element in the first control unit respectively receive the first control signal, the second control signal and the third control signal; third terminals of the first switching element, the second switching element and the third switching element in the second control unit respectively receive the first control signal, the second control signal and the third control signal; third terminals of the first switching element, the second switching element and the third switching element in the third control unit respectively receives the third control signal, the first control signal and the second control signal;
wherein, when the first control signal is effective, the first sub-pixel in the first pixel unit, the first sub-pixel in the second pixel unit and the second sub-pixel in the third pixel unit are charged simultaneously;
when the second control signal is effective, the second sub-pixel in the first pixel unit, the second sub-pixel in the second pixel unit and the third sub-pixel in the third pixel unit are charged simultaneously; and
when the third control signal is effective, the third sub-pixel in the first pixel unit, the third sub-pixel in the second pixel unit and the first sub-pixel in the third pixel unit are charged simultaneously.

4. The liquid crystal display according to claim 1, wherein, the first control signal, the second control signal and the third control signal are sequentially a high-level signal in the scanning period of one scanning line.

5. A liquid crystal display, comprising:
multiple data lines, multiple scanning lines and multiple pixel units, wherein, each pixel unit is connected with a corresponding data line and a corresponding scanning line, each pixel unit includes at least two sub-pixels arranged sequentially and having different colors, and the at least two sub-pixels having different colors in each pixel unit is charged by a same corresponding data line; and
a control circuit for receiving multiple control signals and controlling the sub-pixels having different colors in the multiple pixel units to be charged simultaneously, wherein the multiple control signals are effective in a time-division manner in a scanning period of one scanning line in order to finish a charging of all sub-pixels corresponding to the one scanning line in the scanning period.

6. The liquid crystal display according to claim 5, wherein, the control circuit includes multiple control units corresponding to the multiple data lines one by one, each control unit includes a first switching element, a second switching element and a third switching element, each pixel unit includes a first sub-pixel, a second sub-pixel and a third sub-pixel having different colors, and the multiple control signals includes a first control signal, a second control signal and a third control signal;
first terminals of the first switching element, the second switching element and the third switching element are respectively connected with the first sub-pixel, the second sub-pixel and the third sub-pixel; second terminals of the first switching element, the second switching element and the third switching element are connected with a same corresponding data line after being connected with each other; third terminals of the first switching element, the second switching element and the third switching element are respectively connected with the first control signal, the second control signal and the third control signal; and
each control unit has an arrangement manner for the control signals, and in three control units arranged sequentially, three arrangement manners of the control signals received at the third terminals of the first switching elements, the second switching elements and the third switching elements are different from each other or are the same partially such that the sub-pixels which are charged simultaneously are not a single color.

7. The liquid crystal display according to claim 6, wherein, the three control units arranged sequentially are respectively denoted as a first control unit, a second control unit and a third control unit; three pixel units correspondingly connected with the first control unit, the second control unit and the third control unit arranged sequentially are respectively denoted as a first pixel unit, a second pixel unit and a third pixel unit;
wherein, third terminals of the first switching element, the second switching element and the third switching element in the first control unit respectively receive the first control signal, the second control signal and the third control signal; third terminals of the first switching element, the second switching element and the third switching element in the second control unit respectively receive the third control signal, the first control signal and the second control signal; third terminals of the first switching element, the second switching element and the third switching element in the third control unit respectively receives the second control signal, the third control signal and the first control signal;
wherein, when the first control signal is effective, the first sub-pixel in the first pixel unit, the second sub-pixel in the second pixel unit and the third sub-pixel in the third pixel unit are charged simultaneously;
when the second control signal is effective, the second sub-pixel in the first pixel unit, the third sub-pixel in the second pixel unit and the first sub-pixel in the third pixel unit are charged simultaneously; and
when the third control signal is effective, the third sub-pixel in the first pixel unit, the first sub-pixel in the second pixel unit and the second sub-pixel in the third pixel unit are charged simultaneously.

8. The liquid crystal display according to claim 6, wherein, the three control units arranged sequentially are respectively denoted as a first control unit, a second control unit and a third control unit; three pixel units correspondingly connected with the first control unit, the second control unit and the third control unit arranged sequentially are respectively denoted as a first pixel unit, a second pixel unit and a third pixel unit;
wherein, third terminals of the first switching element, the second switching element and the third switching element in the first control unit respectively receive the first control signal, the second control signal and the third control signal; third terminals of the first switching element, the second switching element and the third switching element in the second control unit respectively receive the first control signal, the second control signal and the third control signal; third terminals of the first switching element, the second switching element and the third switching element in the third control unit respectively receives the third control signal, the first control signal and the second control signal;
wherein, when the first control signal is effective, the first sub-pixel in the first pixel unit, the first sub-pixel in the second pixel unit and the second sub-pixel in the third pixel unit are charged simultaneously;
when the second control signal is effective, the second sub-pixel in the first pixel unit, the second sub-pixel in the second pixel unit and the third sub-pixel in the third pixel unit are charged simultaneously; and
when the third control signal is effective, the third sub-pixel in the first pixel unit, the third sub-pixel in the second pixel unit and the first sub-pixel in the third pixel unit are charged simultaneously.

9. The liquid crystal display according to claim 6, wherein, the first sub-pixel, the second sub-pixel and the third sub-pixel are respectively a red sub-pixel, a green sub-pixel and a blue sub-pixel.

10. The liquid crystal display according to claim 6, wherein, the first switching element, the second switching element and the third switching element are all NMOS transistors; the first terminals, the second terminals and the third terminals of the first switching element, the second switching element and the third switching element are respectively drain electrodes, source electrodes and gate electrodes of NMOS transistors.

11. The liquid crystal display according to claim 10, wherein, the first control signal, the second control signal and the third control signal are sequentially a high-level signal in the scanning period of one scanning line.

12. A control method for a liquid crystal display, comprising steps of:
responding to multiple control signals to control sub-pixels having different colors in multiple pixel units to be charged simultaneously;
wherein, the multiple control signals are effective in a time-division manner in a scanning period of one scanning line in order to finish a charging of all sub-pixels corresponding to the one scanning line in the scanning period.

13. The control method for a liquid crystal display according to claim 12, wherein, the multiple control signals includes a first control signal, a second control signal and a third control signal; each pixel unit includes a first sub-pixel, a second sub-pixel and a third sub-pixel having different colors; three of the pixel units arrange sequentially are respectively denoted as a first pixel unit, a second pixel unit and a third pixel unit; and in the step of responding to multiple control signals to control sub-pixels having different colors in multiple pixel units to be charged simultaneously includes:
responding to the first control signal to control the first sub-pixel in the first pixel unit, the second sub-pixel in the second pixel unit and the third sub-pixel in the third pixel unit to be charged simultaneously;
responding to the second control signal to control the second sub-pixel in the first pixel unit, the third sub-pixel in the second pixel unit and the first sub-pixel in the third pixel unit to be charged simultaneously; and
responding to the third control signal to control the third sub-pixel in the first pixel unit, the first sub-pixel in the second pixel unit and the second sub-pixel in the third pixel unit to be charged simultaneously.

14. The control method for a liquid crystal display according to claim 12, wherein, the multiple control signals includes a first control signal, a second control signal and a third control signal; each pixel unit includes a first sub-pixel, a second sub-pixel and a third sub-pixel having different colors; three of the pixel units arrange sequentially are respectively denoted as a first pixel unit, a second pixel unit and a third pixel unit; and in the step of responding to multiple control signals to control sub-pixels having different colors in multiple pixel units to be charged simultaneously includes:
responding to the first control signal to control the first sub-pixel in the first pixel unit, the first sub-pixel in the second pixel unit and the second sub-pixel in the third pixel unit to be charged simultaneously;
responding to the second control signal to control the second sub-pixel in the first pixel unit, the second sub-pixel in the second pixel unit and the third sub-pixel in the third pixel unit to be charged simultaneously; and
responding to the third control signal to control the third sub-pixel in the first pixel unit, the third sub-pixel in the second pixel unit and the first sub-pixel in the third pixel unit to be charged simultaneously.
